(19) United States
(12) Patent Application Publication
(10) Pub. No.: US 2011/0109239 A1
(43) Pub. Date: May 12, 2011

(54) ILLUMINATION CONTROL DEVICE

(75) Inventor: Naoto KOJIMA, Tokyo (JP)

(73) Assignee: MERSTech, Inc

(21) Appl. No.: 13/000,631

(22) PCT Filed: Jul. 3, 2008
(86) PCT No.: PCT/JP2008/001774

§ 371 Date: Dec. 22, 2010

(51) Int. Cl. H05B 41/16

(52) U.S. Cl. 315/250

(57) ABSTRACT

A lighting control device 100 comprises a first MERS 30a adjusting the voltage magnitude and current phase output to a first system including lighting lamps 60a to 60c, a second MERS 30b adjusting the voltage magnitude and current phase output to a second system including lighting lamps 60d to 60f, a first adjustment part 70b and second adjustment part 70b controlling the first MERS 30a and second MERS 30b, and a power factor adjustment instruction part 80 giving instructions on the current phase adjustment and light modulation. The power factor adjustment instruction part 80 advances the phase of the current flowing through the lighting lamps 60a to 60c with respect to the phase of the source voltage and delays the phase of the current flowing through the lighting lamps 60d to 60f with respect to the phase of the source voltage so as to adjust the power factor of an alternating current voltage source 20, and adjusts the voltage output to the lighting lamps 60a to 60f so as to adjust the brightness of the lighting lamps 60a to 60f.

### TECHNICAL FIELD

The present invention relates to a lighting control device.

### BACKGROUND ART

A switch capable of turning on/off both, forward and backward, currents only by the gate control of four reverse conducting elements having no reverse blocking capability, and accumulating the magnetic energy of the current in a capacitor at the current cutoff and releasing the magnetic energy to a load side through the elements having the ON gate so as to recover the magnetic energy without any loss is proposed (see Patent Literature 1). This switch is a low-loss magnetic energy recovery switch capable of controlling both, forward and backward, currents and called MERS (magnetic energy recovery switch). The Patent Literature 1 discloses a full-bridge type MERS.

As the elements having no reverse blocking capability, elements having forward control capability such as power MOSFETs and transistors inverse-parallel-connected with the diodes are used in MERS. MERS is constructed by connecting a bridge circuit consisting of four such semiconductor elements, and a capacitor absorbing and releasing the magnetic energy at the positive and negative terminals of the bridge circuit. With the gate phases of the four semiconductor elements being controlled, the MERS allows a current to flow in both directions.

Furthermore, among the four, bridge-connected semiconductor elements, two semiconductor elements on each diagonal line are paired and two pairs are turned on/off in sync with the power source frequency in the manner that one pair is turned on while the other pair is turned off. Furthermore, in sync with the timing at which they are turned on/off, the capacitor is repeatedly charged/discharged with the magnetic energy.

When one pair has the OFF gate and the other pair has the ON gate, the forward current flows through the first diode of the other pair, the capacitor, and the second diode of the other pair, charging the capacitor. In other words, the magnetic energy of the circuit is accumulated in the capacitor. The magnetic energy in the circuit during the current cutoff is accumulated in the capacitor until the voltage of the capacitor is raised and the current becomes zero. The current cutoff ends when the voltage of the capacitor is raised until the capacitor current becomes zero. At this point, the other pair already has the ON gate. Then, the charge in the capacitor is discharged to the load side through the turned-on semiconductor elements and the magnetic energy accumulated in the capacitor is recovered for the load side.

As described above, the output voltage magnitude and current phase of MERS can be controlled on an arbitrary basis by controlling the ON/OFF gate phase of the two pairs of semiconductor elements, each pair consisting of two semiconductor elements on each diagonal line among four semiconductor elements, whereby a desired power factor can be obtained.

### Patent Literature 1: Japanese Patent No. 3634982

### DISCLOSURE OF INVENTION

### Problem to be Solved by the Invention

When the load connected to the power source is an inductive load, the current phase delays with respect to the source voltage phase because of internal reactance and, therefore, the power factor of the power source is lowered. With the power factor being lowered, the electric power supplied from the power transmission side is partly returned to the power transmission side from the load side as it is. In other words, part of the electric power becomes reactive power that reciprocates between the power transmission side and load side through power lines. Generally, power loss occurs in power lines when electric power is supplied through power lines.

Recently, environmental issues such as air pollution and global warming have become particularly serious and, in addressing such environmental issues, proactive efforts have been made for low energy consumption (energy saving). Wasteful energy consumption can be a factor of the global warming and air pollution. As a solution to environmental issues, low power loss is required.

In this regard, if the power factor of a power source is improved, the reactive power quantity is decreased for transmitting the same quantity of electricity and the current flowing through power lines is reduced, whereby the transmission loss is decreased. The power factor of a power source can be improved by adjusting the voltage applied to a load to advance the phase of the current flowing through the load. However, when the load is a lighting lamp, the electric power has to be supplied so that the lighting lamp can maintain a necessary level of brightness. Furthermore, a raised supply voltage for adjusting the power factor of the power source may rather increase wasteful power consumption. For this reason, when the load is a lighting lamp, the current phase cannot simply be adjusted for improving the power factor of the power source.

The present invention is invented in view of the above circumstances and an exemplary object of the present invention is to provide a technique for improving the power factor of a power source to which multiple lighting lamps are connected and modulating the light of the lighting lamps.

### Means to solve the problem

In order to solve the above problem, an exemplary aspect of the present invention provides a lighting control device, comprising a first adjustment switch connected between a first system including one or multiple lighting lamps including an inductive load or one or multiple lighting lamps connected to an inductive load and a power source for adjusting the voltage magnitude and current phase output from said power source to the one or multiple lighting lamps of said first system; a second adjustment switch connected between a second system including one or multiple lighting lamps including an inductive load or one or multiple lighting lamps connected to an inductive load and the power source for adjusting the voltage magnitude and current phase output from the power source to the one or multiple lighting lamps of said second system; a first adjustment part controlling said first adjustment switch; a second adjustment part controlling said second adjustment switch; and a power factor adjustment instruction part instructing said first and second adjustment parts on the current phase adjustment and light modulation, wherein said power factor adjustment instruction part instructs said first and second adjustment parts to advance the phase of the current flowing through the one or multiple lighting lamps of said first system with respect to the phase of the source voltage and delay the phase of the current flowing through the one or multiple lighting lamps of said second system with respect to the phase of the source voltage so as to adjust the power factor of the power source, and to adjust the voltage output to the one or multiple lighting lamps of said first and second systems so as to adjust the brightness of the one or multiple lighting lamps of said first and second systems.

### Effect of the invention

The present invention can improve the power factor of a power source to which one or multiple lighting lamps are connected and modulate the light of the lighting lamps.

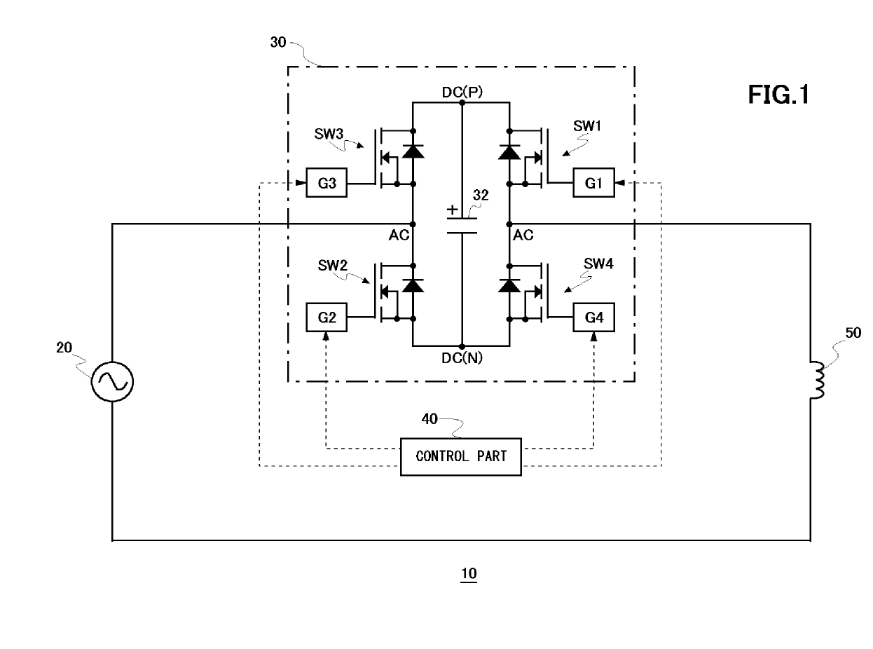

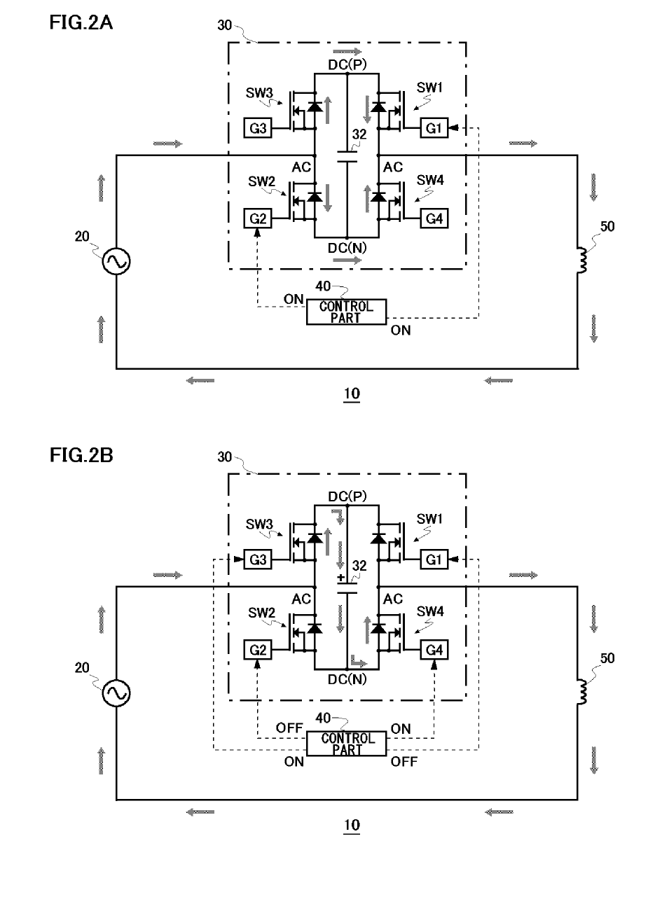

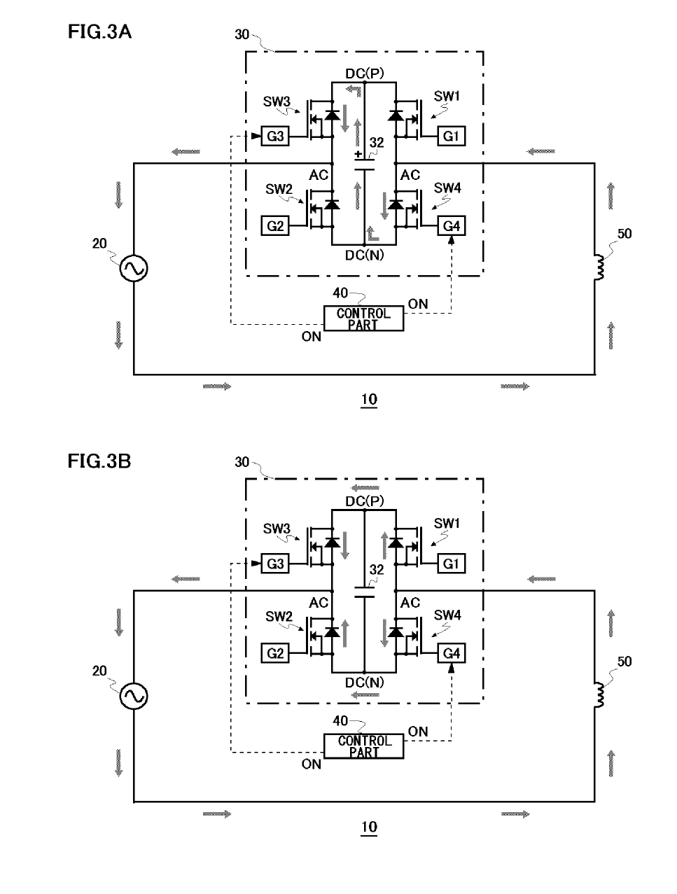

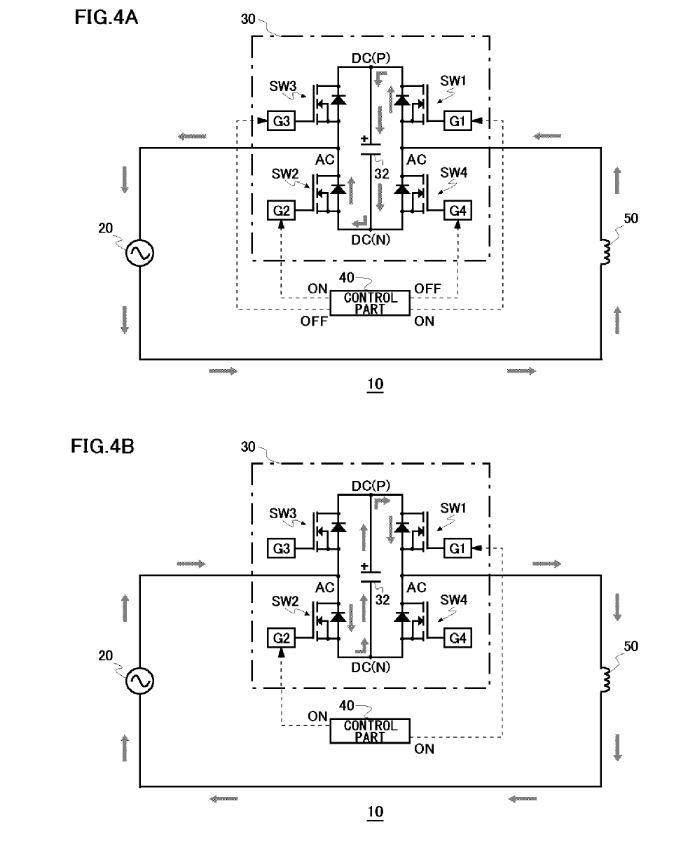

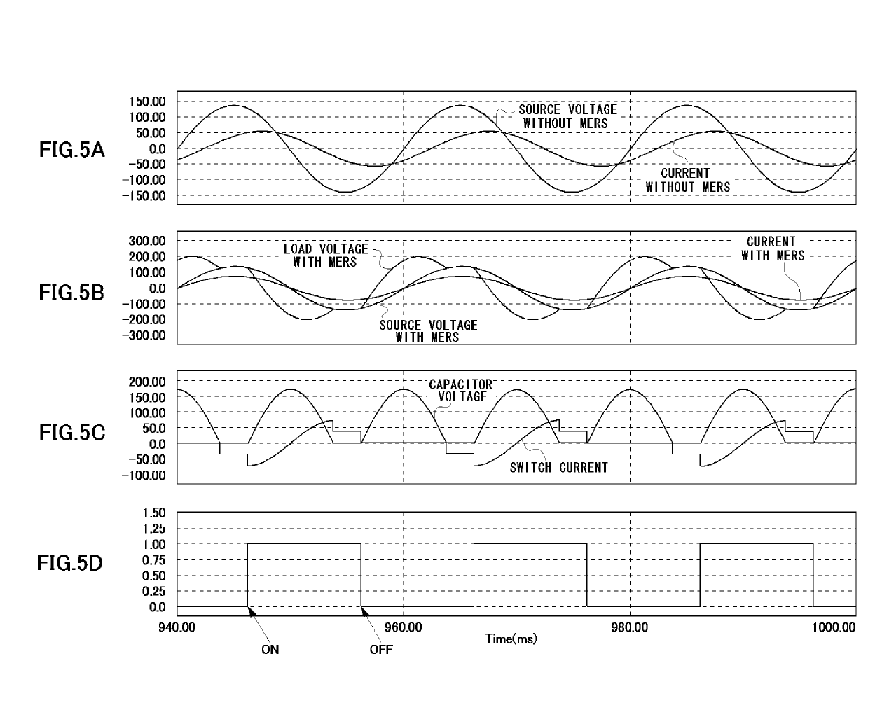

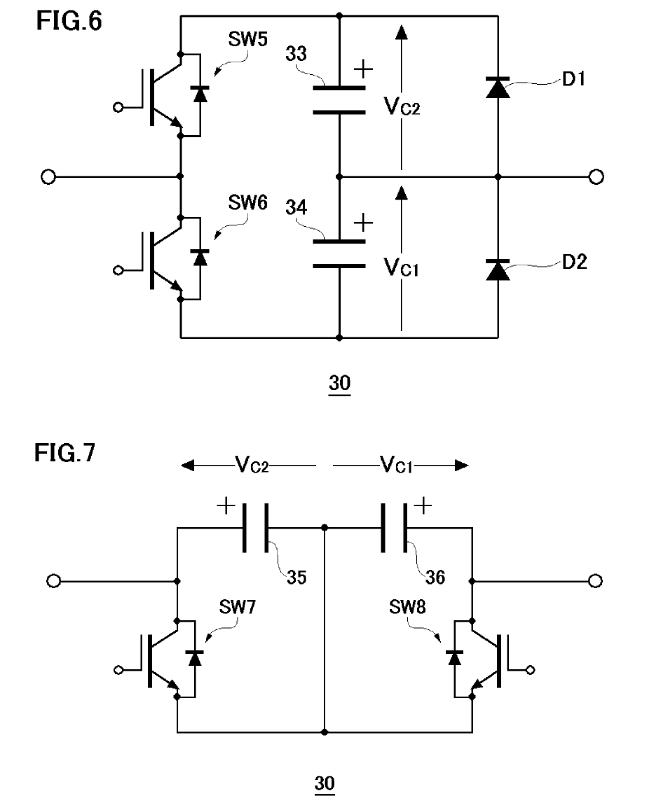

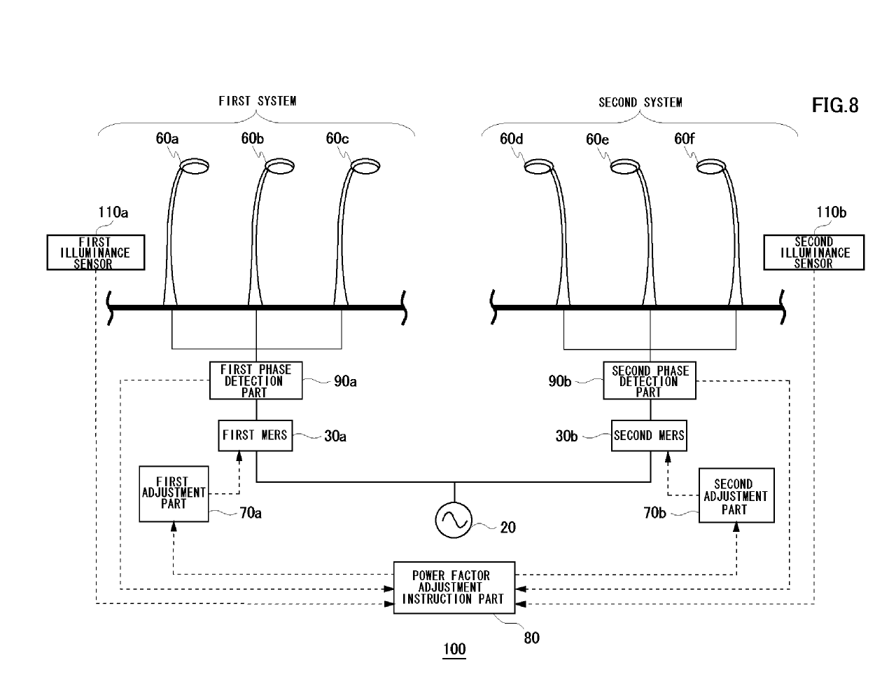

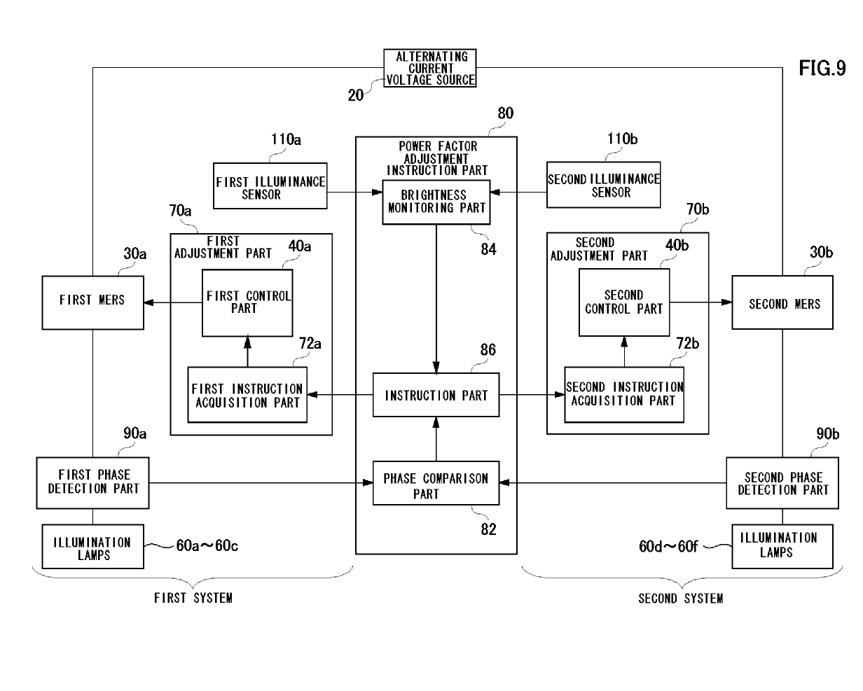

### BRIEF DESCRIPTION OF DRAWINGS

[FIG. 1] An illustration showing the basic configuration of a MERS-incorporated system;

[FIG. 2] FIGS. 2A and 2B are illustrations for explaining the MERS switching control by the control part;

[FIG. 3] FIGS. 3A and 3B are illustrations for explaining the MERS switching control by the control part;

[FIG. 4] FIGS. 4A and 4B are illustrations for explaining the MERS switching control by the control part;

[FIG. 5] FIGS. 5A, 5B, 5C, and 5D are charts for explaining the operation results of the MERS-incorporated system;

[FIG. 6] An illustration showing another MERS embodiment;

[FIG. 7] An illustration showing another MERS embodiment;

[FIG. 8] An illustration schematically showing the configuration of a lighting control device according to Embodiment 1; and

[FIG. 9] A functional block diagram for explaining the schematic configuration of the first adjustment part and power factor adjustment instruction part.

### DESCRIPTION OF SYMBOLS

SW1, SW2, SW3, SW4, SW5, SW6, SW7, SW8 reverse conducting semiconductor switch; D1, D2 diode; 10 MERS-incorporated system; 20 alternating current voltage source; 30 magnetic energy recovery switch (MERS); 30a first MERS; 30b second MERS; 32, 33, 34, 35, 36 capacitor; 40 control part; 40a first control part; 40b second control part; 50 inductive load; 60, 60a to 60f lighting lamp; 70a first adjustment part; 70b second adjustment part; 72a first instruction acquisition part; 72b second instruction acquisition part; 80 power factor adjustment instruction part; 82 phase comparison part; 84 brightness monitoring part; 86 instruction part; 90a first phase detection part; 90b second phase detection part; 100 lighting control device; 110a first illuminance sensor; 110b second illuminance sensor

### BEST MODE FOR CARRYING OUT THE INVENTION

The present invention will be described hereafter based on a preferable embodiment with reference to the drawings. In the drawings, the same or equivalent components, members, and processes are referred to by the same reference numbers and duplicated explanation will be eliminated as appropriate. The embodiment is given by way of example and does not confine the present invention. All characteristics described in the embodiment and their combinations are not necessarily essential for the present invention.

### Embodiment 1

The lighting control device according to this embodiment comprises a first adjustment switch connected between a first system including one or multiple lighting lamps having an inductive load and an alternating current source for adjusting the voltage magnitude and current phase output from the alternating current source to the lighting lamps of the first system; a second adjustment switch connected between a second system including one or multiple lighting lamps having an inductive load and the alternating current source for adjusting the voltage magnitude and current phase output from the alternating current source to the lighting lamps of the second system; a first adjustment part controlling the first adjustment switch; a second adjustment part controlling the second adjustment switch; and a power factor adjustment instruction part instructing the first and second adjustment parts on the current phase adjustment and light modulation. The adjustment switches are, for example, a magnetic energy recovery switch (MERS).

The power factor adjustment instruction part instructs the first and second adjustment parts to advance the phase of the current flowing through the lighting lamps of the first system with respect to the phase of the source voltage and delay the phase of the current flowing through the lighting lamps of the second system with respect to the phase of the source voltage so as to adjust the power factor of the alternating current source and to adjust the voltage output to the lighting lamps of the first and second systems so as to adjust the brightness of the lighting lamps of the first and second systems.

First, the configuration and operation of MERS as an adjustment switch will be described. In this embodiment, a MERS-incorporated system in which MERS is series-connected between an alternating current voltage source and a dielectric load will be described as an example. Incorporating MERS in an alternating current voltage source leads to configuring an alternating current source device. Incorporating MERS in an inductive load leads to configuring a MERS-incorporated load.

FIG. 1 is an illustration showing the basic configuration of a MERS-incorporated system 10.

In FIG. 1, the MERS-incorporated system 10 comprises an alternating current voltage source 20 and an inductive load 50 having inductance. MERS 30 is inserted between the alternating current voltage source 20 and inductive load 50. The MERS-incorporated system 10 further comprises a control part 40 controlling the switching of the MERS 30.

The MERS 30 is a magnetic energy recover switch capable of controlling both, forward and backward, currents and recovering the magnetic energy for the load side without any loss. The MERS 30 comprises a bridge circuit consisting of four reverse conducting semiconductor switches SW1, SW2, SW3, and SW4, and an energy-accumulating capacitor 32 for absorbing the magnetic energy of the current flowing through the circuit when the bridge circuit is switched off.

In the bridge circuit, the reverse conducting semiconductor switches SW1 and SW4 are series-connected and the reverse conducting semiconductor switches SW2 and SW3 are series-connected, and they are further parallel-connected.

The capacitor 32 is connected to a direct current terminal DC (P) at the connection point between the reverse conducting semiconductor switches SW1 and SW3 and to a direct current terminal DC (N) at the connection point between the reverse conducting semiconductor switches SW2 and SW4. Furthermore, the alternating current voltage source 20 and inductive load 50 are series-connected to an alternating current terminal at the connection point between the reverse conducting semiconductor switches SW1 and SW4 and to an alternating current terminal at the connection point between the reverse conducting semiconductor switches SW2 and SW3.

A first pair consisting of the reverse conducting semiconductor switches SW1 and SW2 on one diagonal line of the MERS 30 and a second pair consisting of the reverse conducting semiconductor switches SW3 and SW4 on the other diagonal line are alternatively turned on/off in sync with the power supply frequency. In other words, one pair is turned on while the other pair is turned off. Then, for example, when the first pair has the OFF gate and the second pair has the ON gate, the forward current flows through the reverse conducting semiconductor switch SW3 of the second pair, the capacitor 32, and the reverse conducting semiconductor switch SW4, charging the capacitor 32. In other words, the magnetic energy of the circuit is accumulated in the capacitor 32.

The magnetic energy in the circuit at the current cutoff is accumulated in the capacitor until the voltage of the capacitor 32 is raised and the current becomes zero. The current cutoff ends when the voltage of the capacitor 32 is raised and the capacitor current becomes zero. At this point, the second pair already has the ON gate, the charge in the capacitor 32 is discharged to the inductive load 50 through the turned-on reverse conducting semiconductor switches SW3 and SW4 and the magnetic energy accumulated in the capacitor 32 is recovered for the inductive load 50.

As the current is turned on/off, a pulse voltage is applied to the inductive load 50. The magnitude of the voltage can be within the acceptable withstand voltage range of the reverse conducting semiconductor switches SW1 to SW4 and inductive load 50 according to the capacitance of the capacitor 32. Furthermore, unlike traditional series power factor-improving capacitors, a direct current capacitor can be used in the MERS 30. The reverse conducting semiconductor switches SW1 to SW4 are, for example, power MOSFETs and have gates G1, G2, G3, and G4, respectively. Body diodes are parallel-connected to the channels of the reverse conducting semiconductor switches SW1 to SW4, respectively.

The MERS 30 may further have diodes inverse-parallel-connected to the reverse conducting semiconductor switches SW1 to SW4, respectively, in addition to the body diodes. Here, the reverse conducting semiconductor switches SW1 to SW4 can be elements such as IGBTs or transistors inverse-parallel-connected with diodes.

The control part 40 controls the switching of the reverse conducting semiconductor switches SW1 to SW4 of the MERS 30. More specifically, the control part 40 transmits control signals to the gates G1 to G4 so as to control the ON/OFF operation of the pair consisting of the reverse conducting semiconductor switches SW1 and SW 2 on one diagonal line of the bridge circuit of the MERS 30 and the ON/OFF operation of the pair consisting of the reverse conducting semiconductor switches SW3 and SW 4 on the other diagonal line in the manner that one pair is turned on and the other pair is turned off at the same time in every half cycle.

The switching control of the MERS 30 by the control part 40 will be described in detail hereafter. FIGS. 2A and 2B, FIGS. 3A and 3B, and FIGS. 4A and 4B are illustrations for explaining the switching control of the MERS 30 by the control part 40.

First, when the control part 40 turns on the reverse conducting semiconductor switches SW1 and SW2 while the capacitor 32 has no charged voltage, the current flows through the reverse conducting semiconductor switches SW3 and SW1 and through the reverse conducting semiconductor switches SW2 and SW4, establishing a parallel conduction state.

Then, at a given time before the voltage of the alternating current voltage source 20 is reversed, for example approximately 2 ms before, the control part 40 turns off the reverse conducting semiconductor switches SW1 and SW2. Then, as shown in FIG. 2B, the current flows through the reverse conducting semiconductor switch SW3, the capacitor 32, and the reverse conducting semiconductor switch SW4. Consequently, the magnetic energy is absorbed by (charged in) the capacitor 32. In this embodiment, the reverse conducting semiconductor switches SW3 and SW4 are turned on when the reverse conducting semiconductor switches SW1 and SW2 are turned off.

After charging the capacitor 32 is completed, namely the voltage of the capacitor 32 is raised to a given value or higher, the current is cut off. Then, when the voltage of the alternating current voltage source 20 is reversed, the reverse conducting semiconductor switches SW3 and SW4 are already turned on and the capacitor 32 has a charged voltage; therefore, as shown in FIG. 3A, the current flows through the reverse conducting semiconductor switch SW4, the capacitor 32, and the reverse conducting semiconductor switch SW3. Then, the magnetic energy accumulated in the capacitor 32 is released (discharged).

Then, after discharging the capacitor 32 is completed, as shown in FIG. 3B, the current flows through the reverse conducting semiconductor switches SW1 and SW3 and through the reverse conducting semiconductor switches SW4 and SW2, establishing a parallel conductive state.

Then, at a given time before the voltage of the alternating current voltage source 20 is reversed, the control part 40 turns off the reverse conducting semiconductor switches SW3 and SW4. Therefore, as shown in FIG. 4A, the current flows through the reverse conducting semiconductor switch SW1, the capacitor 32, and the reverse conducting semiconductor switch SW2. Consequently, the magnetic energy is absorbed by the capacitor 32. In this embodiment, the reverse conducting semiconductor switches SW1 and SW2 are turned on when the reverse conducting semiconductor switches SW3 and SW4 are turned off.

After charging the capacitor 32 is completed, the current is cut off. Then, when the voltage of the alternating current voltage source 20 is reversed, the reverse conducting semiconductor switches SW1 and SW2 are already turned on and the capacitor 32 has a charged voltage; therefore, as shown in FIG. 4B, the current flows through the reverse conducting semiconductor switch SW2, the capacitor 32, and the reverse conducting semiconductor switch SW1. Then, the magnetic energy accumulated in the capacitor 32 is released. After discharging the capacitor 32 is completed, the parallel conduction state as shown in FIG. 2A is established and the above operations are repeated. In this way, with the two facing pairs of revere-conductive type semiconductor switches being made conductive alternatively, the MERS 30 can allow a current to flow in either direction.

The above switching control of the MERS 30 has the following effects. FIGS. 5A, 5B, 5C, and 5D are charts for explaining the operation results of the MERS-incorporated system 10. FIG. 5A shows the waveforms of the source voltage and current when the MERS 30 is not incorporated. FIG. 5B shows the waveforms of the source voltage, current, and load voltage when the MERS 30 is incorporated. FIG. 5C shows the waveforms of the capacitor voltage and current flowing through the reverse conducting semiconductor switch SW1. FIG. 5D shows the timing of the reverse conducting semiconductor switch SW1 being turned on.

As shown in FIG. 5A, when the MERS 30 is not incorporated, the current phase is delayed with respect to the source voltage phase under the influence of the inductive load 50. Therefore, the power factor of the alternating current voltage source 20 is small than 1. On the other hand, when the MERS 30 is series-connected between the alternating current voltage source 20 and inductive load 50, the current phase advances as shown in FIG. 5B. Therefore, the power factor of the alternating current voltage source 20 can be 1.

In other words, with the gate phases of two pairs of reverse conducting semiconductor switches SW1 to SW4, each pair consisting of two reverse conducting semiconductor switches on either diagonal line, being adjusted, the MERS 30 accumulates the magnetic energy of the inductive load 50 in the capacitor 32 and advances the current phase, whereby the power factor of the alternating current voltage source 20 can be 1. Furthermore, the MERS 30 can not only advance the current phase but also control the current phase on an arbitrary basis, whereby the power factor can be adjusted on an arbitrary basis. Furthermore, with the magnetic energy of the inductive load 50 being accumulated in the capacitor 32 and the accumulated magnetic energy being recovered for the inductive load 50, the load voltage can be increased/decreased in a non-stepwise manner.

As shown in FIG. 5C and FIG. 5D, when the reverse conducting semiconductor switch SW1 is turned on, the capacitor voltage is zero and the current flowing through the reverse conducting semiconductor switch SW1 is equal to the current flowing through the diode of the reverse conducting semiconductor switch SW1 in the parallel conductive state. The capacitor voltage is also zero when the reverse conducting semiconductor switch SW1 is turned off. In other words, the switching occurs when the voltage and current are zero. Therefore, no switching loss occurs. The other three reverse conducting semiconductor switches SW2 to SW4 are switched in sync with the reverse conducting semiconductor switch SW1 and the same results are obtained.

The charging/discharging cycle of the capacitor 32 is half the resonance period between the inductive load 50 and capacitor 32. When the switching cycle is longer than the resonance period between the inductive load 50 and capacitor 32, the MERS 30 can normally undergo switching with the voltage and current being zero, namely soft switching.

Unlike a conventional voltage type inverter, the capacitor 32 used in the MERS 30 is intended only to accumulate the magnetic energy of the inductance in the circuit. Therefore, the capacitance of the capacitor 32 can be significantly smaller than the voltage source capacitor of a conventional voltage type inverter. The capacitance is determined so that the resonance period with the load is shorter than the switching frequency.

When the MERS 30 is used as a gate pulse generation device, each MERS 30 can be given a unique ID number, which is used in receiving control signals from an external source to control the MERS 30. For example, radio control signals are transmitted through communication networks such as the Internet for wireless control of the MERS 30.

In the above-described MERS-incorporated system 10, the MERS 30 is composed of a bridge circuit consisting of four reverse conducting semiconductor switches SW1 to SW4 and a capacitor 32 connected between the direct current terminals of the bridge circuit. The MERS 30 can have the following structure.

FIGS. 6 and 7 show other embodiments of the MERS 30.

The MERS 30 shown in FIG. 6 is of a vertical half-bridge type composed of two reverse conducting semiconductor switches, two diodes, and two capacitors while the above MERS composed of four reverse conducting semiconductor switches SW1 to SW4 and a capacitor 32 is of a full-bridge type.

More specifically, the vertical half-bridge structure MERS 30 includes two series-connected reverse conducting semiconductor switches SW5 and SW6, two capacitors 33 and 34 series-connected to each other and parallel-connected to the two reverse conducting semiconductor switches SW5 and SW6, and two diodes D1 and D2 parallel-connected to the capacitors 33 and 34, respectively.

The MERS 30 shown in FIG. 7 is of a horizontal half-bridge type. The horizontal half-bridge type MERS is composed of two reverse conducting semiconductor switches and two capacitors.

More specifically, the horizontal half-bridge structure MERS 30 includes a reverse conducting semiconductor switch SW7 and a capacitor 35, which are series-connected on a first path, a reverse conducting semiconductor switch SW8 and a capacitor 36, which are series-connected on a second path that is parallel to the first path, and a line parallel-connected to the first and second paths.

The lighting control device according to this embodiment will be described hereafter.

FIG. 8 is an illustration schematically showing the lighting control device according to Embodiment 1.

As shown in FIG. 8, the lighting control device 100 of this embodiment is provided with a first MERS 30a between lighting lamps 60a to 60c and an alternating current voltage source 20 and a second MERS 30b between lighting lamps 60d to 60f and the alternating current voltage source 20. The lighting lamps 60 are lighting lamps, each lamp has an inductive load, or lighting lamps, each lamp is connected to an inductive load. Examples of lighting lamps having an inductive load include discharge lamps. The discharge lamps can be, for example, fluorescent lamps, mercury lamps, sodium lamps, or neon lamps. Examples of lighting lamp connected to an inductive load include a light source such as an incandescent lamp and LED having no inductive load and to which a reactor is connected. In this embodiment, the lighting lamps 60 are discharge lamps. The number of lighting lamps 60 is not particularly restricted. At least one lighting lamp 60 may be connected to each of the first and second MERS 30a and 30b.

The lighting control device 100 further comprises a first adjustment part 70a for controlling the gate phase angle of the first MERS 30a so as to adjust the output voltage magnitude and current phase of the first MERS 30a. The lighting control device 100 further comprises a second adjustment part 70b for controlling the gate phase angle of the second MERS 30b so as to adjust the output voltage magnitude and current phase of the second MERS 30b. The lighting control device 100 further comprises a power factor adjustment instruction part 80 instructing the first and second adjustment parts 70a and 70b on the current phase adjustment and light modulation, a first phase detection part 90a detecting the phase of the current flowing through the lighting lamps 60a to 60c, and a second phase detection part 90b detecting the phase of the current flowing through the lighting lamps 60d to 60f. More specifically, the first and second phase detection parts 90a and 90b detect the phase of the current with respect to the phase of the voltage of the alternating current voltage source 20.

The lighting control device 100 further comprises a first illuminance sensor 110a detecting the illuminance within the lighting range of the lighting lamps 60a to 60c as a first brightness detection means for detecting the brightness of the lighting lamps 60a to 60c. The lighting control device 100 further comprises a second illuminance sensor 110b detecting the illuminance within the lighting range of the lighting lamps 60d to 60f as a second brightness detection means for detecting the brightness of the lighting lamps 60d to 60f. The numbers of the first and second illuminance sensors 110a and 110b are not particularly restricted and at least one per system may be provided.

In the lighting control device 100 of this embodiment, a first system including the lighting lamps 60a to 60c and a second system including the lighting lamps 60d to 60f are parallel-connected to the same alternating current power source, namely the alternating current voltage source 20.

FIG. 9 is a functional block diagram for explaining the schematic configuration of the first adjustment part 70a, second adjustment part 70b, and power factor adjustment instruction part 80.

As shown in FIG. 9, the first adjustment part 70a comprises a first control part 40a transmitting control signals to the gates G1 to G4 of the reverse conducting semiconductor switches SW1 to SW4 to adjust the output voltage magnitude of the first MERS 30a and simultaneously adjust the current phase. The first adjustment part 70a further comprises a first instruction acquisition part 72a receiving instruction a signal from an instruction part 86 of the power factor adjustment instruction part 80, which will be described later, and transmitting them to the first control part 40a.

On the other hand, the second adjustment part 70b comprises a second control part 40b transmitting control signals to the gates G1 to G4 of the reverse conducting semiconductor switches SW1 to SW4 to adjust the output voltage magnitude of the second MERS 30b and simultaneously adjust the current phase. The second adjustment part 70b further comprises a second instruction acquisition part 72b receiving instruction a signal from an instruction part 86 of the power factor adjustment instruction part 80, which will be described later, and transmitting it to the second control part 40b.

The power factor adjustment instruction part 80 comprises a phase comparison part 82 acquiring current phase information from the first phase detection part 90a and further acquiring current phase information from the second phase detection part 90b, comparing the phase of the current flowing through the lighting lamps 60 between the systems, and transmitting the comparison results to the instruction part 86. The power factor adjustment instruction part 80 further comprises a brightness monitoring part 84 acquiring the detection result of the first illuminance sensor 110a and the detection result of the second illuminance sensor 110b, monitoring the brightness of the lighting lamps 60 of each of the systems, and transmitting the monitoring results to the instruction part 86. The brightness monitoring part 84 retains a brightness/illuminance correspondence table associating the brightness of the lighting lamps 60 with the illuminance within the lighting region. The brightness monitoring part 84 further comprises a not-shown parameter retention part, retaining predetermined necessary brightness values of the lighting lamps. Here, the “necessary brightness values” are a range of values including an upper limit and a lower limit of the brightness necessary in the region where the lighting lamps 60 are provided and appropriately determined according to the site where the lighting lamps 60 are provided. The values can be obtained empirically. The upper limit of the necessary brightness values serves to prevent the brightness of the lighting lamps 60 from excessively being raised and reduce wasteful power consumption.

The power factor adjustment instruction part 80 further comprises an instruction part 86 instructing the first adjustment part 70a and second adjustment part 70b on the current phase adjustment and light modulation based on the information received from the phase comparison part 82 or the information received from the brightness monitoring part 84.

The operation of the lighting control device 100 will be described hereafter.

For example, first, the power factor adjustment instruction part 80 instructs the first adjustment part 70a to adjust the first MERS 30a so that the phase of the current flowing through the first system is advanced with respect to the source voltage phase and the brightness of the lighting lamps 60a to 60c of the first system complies with the necessary illuminance values. Then, the power factor adjustment instruction part 80 acquires from the first phase detection part 90a the phase information of the current flowing through the lighting lamps 60a to 60c and instructs the second adjustment part 70b to delay the phase of the current flowing through the second system with respect to the source voltage phase so that the power factor of the alternating current voltage source 20 becomes equal to or close to 1.

Subsequently, the power factor adjustment instruction part 80 acquires from the second illuminance sensor 110b the illuminance value within the lighting range of the lighting lamps 60d to 60f of the second system, makes reference to the brightness/illuminance correspondence table, and converts the illuminance value to the brightness value of the lighting lamps 60c to 60f. Here, for example, when the brightness value of the lighting lamps 60d to 60f is lower than the lower limit of the necessary brightness values, the power factor adjustment instruction part 80 instructs the second adjustment part 70b to increase the brightness of the lighting lamps 60d to 60f to a necessary brightness value. Receiving the instruction from the power factor adjustment instruction part 80, the second adjustment part 70b increases the brightness of the lighting lamps 60d to 60f by increasing the output voltage magnitude of the second MERS 30b, whereby the current phase is accordingly changed for the advance. Then, the power factor of the alternating current voltage source 20 is lowered.

The power factor adjustment instruction part 80 acquires from the second phase detection part 90b the phase information of the current flowing through the lighting lamps 60d to 60f and adjusts the phase of the current flowing through the first system for the delay so that the power factor of the alternating current voltage source 20 becomes equal to or close to 1. When the brightness value of the lighting lamps 60a to 60f is higher than the upper limit of the necessary brightness values, the power factor adjustment instruction part 80 lower the brightness of the lighting lamps 60d to 60f, which causes the phase of the current flowing through the second system to change for the delay; therefore, the power factor adjustment instruction part 80 adjusts the phase of the current flowing through the first system for the advance. In this way, the lighting control device 100 can improve the power factor of the alternating current voltage source 20, preferably making it close to 1 and more preferably making it equal to 1. Furthermore, the lighting control device 100 can adjust the brightness of the lighting lamps 60a to 60c of the first system and the lighting lamps 60d to 60f of the second system for necessary brightness values.

The first and second brightness detection means can be, for example, a voltmeter detecting the voltage output to the illuminating lamps 60. In such a case, it is possible to retain necessary voltage values corresponding to the necessary brightness values in the parameter retention part, detect the voltages output to the first system and second system using a first voltmeter and a second voltmeter, respectively, and adjust the brightness of the lighting lamps 60 between an upper limit voltage value and a lower limit voltage value.

The lighting control device 100, for example, conducts the following control periodically while the lighting lamps 60 are lit up. The power factor adjustment instruction part 80 acquires from the first phase detection part 90a the phase information of the current flowing through the lighting lamps 60a to 60c. Similarly, the power factor adjustment instruction part 80 also acquires from the second phase detection part 90b the phase information of the current flowing through the lighting lamps 60d to 60f. Then, the phase comparison part 82 compares the phase between the current flowing through the lighting lamps 60a to 60c and the current flowing through the lighting lamps 60d to 60f and transmits the comparison results to the instruction part 86.

The instruction part 86 instructs the first adjustment part 70a, for example, to advance the phase of the current flowing through the lighting lamps 60a to 60c of the first system with respect to the source voltage phase. On the other hand, the instruction part 86 instructs the second adjustment part 70b to delay the phase of the current flowing through the lighting lamps 60d to 60f of the second system with respect to the source voltage phase. For example, the advance amount of the phase of the current flowing through the first system connected to the alternating current voltage source 20 is made equal to the delay amount of the phase of the current flowing through the second system connected to the same alternating current voltage source 20. In this way, the power factor of the alternating current voltage source 20 can be improved, preferably being made to be close to 1 and more preferably being made to be equal to 1.

Here, when the current phase of the first system and the current phase of the second system are adjusted to make the power factor of the alternating voltage source 20 close to 1, the brightness of the lighting lamps 60 may excessively be increased and wasteful power consumption may be increased. Therefore, when the brightness of the lighting lamps 60a to 60f that is derived from the detection results of the first and second illuminance sensors 110a and 110b exceeds a given value, the power factor adjustment instruction part 80 may accept the power factor of the alternating current voltage source 20 not being close to 1 and adjust the brightness of the lighting lamps 60 for a given value or lower. Even in such a case, with the current phase of the first system and the current phase of the second system being reversed from each other, the power factor of the alternating current voltage source 20 can be improved.

Furthermore, generally, the electrodes of the lighting lamps 60 deteriorate due to aging and it becomes difficult for the current to flow, decreasing the brightness. Then, the brightness monitoring part 84 of the power factor adjustment instruction part 80 receives the illuminance value within the lighting range of the lighting lamps 60a to 60c of the first system from the first illuminance sensor 110a and the illuminance value within the lighting range of the lighting lamps 60d to 60f of the second system from the second illuminance sensor 110b. Then, the brightness monitoring part 84 derives the brightness values of the lighting lamps 60a to 60f from the illuminance values and compares the values with the necessary brightness values of the lighting lamps that are retained in the parameter retention part.

For example, it is assumed that the brightness of the lighting lamps 60d to 60f of the second system is lower than the necessary brightness as a result of the comparison. In such a case, the brightness monitoring part 84 transmits to the instruction part 86 a signal urging instruction to the second adjustment part 70b to increase the brightness. Urged by the brightness monitoring part 84, the instruction part 86 transmits an instruction to increase the brightness of the lighting lamps 60s to 60f to the second adjustment part 70b. Receiving the instruction from the instruction part 86, the second adjustment part 70b controls the gate phase angles of the second MERS 30b to increase the output voltage magnitude of the second MERS 30b so as to increase the brightness of the lighting lamps 60d to 60f. Consequently, the brightness of the lighting lamps 60 is increased.

On the other hand, when the output voltage magnitude of the second MERS 30b is increased in order to increase the brightness of the lighting lamps 60d to 60f of the second system, the phase of the current flowing through the second system is accordingly changed. Then, the power factor adjustment instruction part 80 compares the current phase between the first system and second system by means of the phase comparison part 82 and instructs the first adjustment part 70a to change the current phase of the first system according to the change amount of the current phase of the second system. In this way, the power factor of the alternating current voltage source 20 can be adjusted along with adjustment of the brightness of the lighting lamps.

The lighting control device 100 can have the following structure. The first MERS 30a and second MERS 30b are each given a unique address so that they can be accessed separately. Then, the power factor adjustment instruction part 80 instructs the first adjustment part 70a and second adjustment part 70b on the current phase adjustment and light modulation through wired or wireless communication via a network such as the Internet and a local area network (LAN).

The function effects of the above-described structures are summarized as follows. In the lighting control device 100 of this embodiment, a first system including lighting lamps 60a to 60c and a second system including lighting lamps 60d to 60f are connected to an alternating current voltage source 20. A first MERS 30a and a second MERS 30b are connected to these systems, respectively. A power factor adjustment instruction part 80 advances the phase of the current flowing through the first system with respect to the source voltage phase and, for example, delays the phase of the current flowing through the second system at the same amount as the advance amount of the current phase of the first system. In this way, the power factor of the alternating current voltage source 20 to which the first system and second system are connected can be adjusted. Consequently, the power factor of the alternating current voltage source 20 is improved and power transmission loss is reduced.

Furthermore, the brightness of the lighting lamps 60 included in each system is monitored along with adjustment of the current phase of each system and the output voltage magnitude of the MERS 30 is adjusted so that the brightness of the lighting lamps 60 complies with necessary brightness. In other words, the current phase of each system is adjusted to the extent that the brightness of the lighting lamps 60 complies with necessary brightness. Then, the light of the lighting lamps 60 can be modulated while the power factor of the alternating current voltage source 20 is improved.

A method of improving the power factor using a phase advance capacitor is already in practical use. The phase advance capacitor is expensive. On the other hand, the lighting control device 100 of this embodiment simply incorporates MERS 30 between lighting lamps 60 and an alternating current voltage source 20. The MERS 30 is simple in structure, small, and inexpensive. Therefore, the lighting control device 100 is easily provided and the installation cost can be significantly low.

In the event that the reverse conducting semiconductor switches SW1 to SW4 of the MERS 30 fail, the alternating current voltage source 20 and lighting lamps 60 simply become conductive and the lighting lamps 60 are never disabled because of failure of the MERS 30. Then, the MERS 30 incorporated between an existing alternating current voltage source 20 and lighting lamps 60 does not cause any problems such as lowered safety.

The lighting control device 100 of this embodiment is applicable on the basis of an electric power distribution system, incoming panel, or distribution board. Among multiple lighting lamps connected to the same electric power distribution system, incoming panel, or distribution board, the phase of the current flowing through lighting lamps 60 of one system is advanced and the phase of the current flowing through the lighting lamps 60 of the other system is delayed. Then, the power factor can be made equal to or close to 1 in each electric power distribution system, incoming panel, or distribution board. The lighting control device 100 is applicable to existing lighting lamps along highways, freeways, or general roads.

The present invention is not confined to the above embodiment and various design modifications or the like can be made based on the knowledge of a person of ordinary skill in the field. Embodiments including such modifications will fall under the scope of the present invention.

For example, the first MERS 30a and second MERS 30b are provided to the first system and second system, respectively, in the above embodiment. For example, the MERS 30 can be provided only to the first system. In such a case, the phase of the current flowing through the second system is delayed because of electric reactance components in the lighting lamps 60. The phase of the current flowing through the first system can be advanced by the amount according to such a delay amount, whereby the power factor of the alternating current voltage source 20 can be improved, preferably being made to be close to 1 and more preferably being made to be equal to 1.

Furthermore, the first system and second system are connected to the alternating current voltage source 20 in the above embodiment. The number of systems is not particularly restricted and a larger number of systems can be connected the alternating current voltage source 20. In such a case, the current phases of multiple systems are adjusted to improve the power factor of the alternating current voltage source 20.

### INDUSTRIAL APPLICABILITY

The present invention is applicable to lighting equipment.

1. A lighting control device, comprising:
a first adjustment switch connected between a first system including one or multiple lighting lamps including an inductive load or one or multiple lighting lamps connected to an inductive load and an alternating current source for adjusting the voltage magnitude and current phase output from said alternating current source to the one or multiple lighting lamps of said first system;
a second adjustment switch connected between a second system including one or multiple lighting lamps including an inductive load or one or multiple lighting lamps connected to an inductive load and said alternating current source for adjusting the voltage magnitude and current phase output from said alternating current source to the one or multiple lighting lamps of said second system;
a first adjustment part controlling said first adjustment switch;
a second adjustment part controlling said second adjustment switch; and
a power factor adjustment instruction part instructing said first and second adjustment parts on the current phase adjustment and light modulation,
wherein said power factor adjustment instruction part instructs said first and second adjustment parts to advance the phase of the current flowing through the one or multiple lighting lamps of said first system with respect to the phase of the source voltage and delay the phase of the current flowing through the one or multiple lighting lamps of said second system with respect to the phase of the source voltage so as to adjust the power factor of said alternating current source, and to adjust the voltage output to the one or multiple lighting lamps of said first and second systems so as to adjust the brightness of the one or multiple lighting lamps of said first and second systems.

2. The lighting control device according to claim 1, wherein said first adjustment switch and second adjustment switch include at least two reverse conducting semiconductor switches and a capacitor for accumulating the magnetic energy of the current at the current cutoff and recovering it for said one or multiple lighting lamps, and the gate phases of said first and second adjustment switches are controlled to adjust the voltage magnitude and current phase output to said one or multiple lighting lamps.

3. The lighting control device according to claim 1 or 2, further comprising
a first phase detection part detecting the phase of the current flowing through the one or multiple lighting lamps of said first system and
a second phase detection part detecting the phase of the current flowing through the one or multiple lighting lamps of said second system,
wherein said power factor adjustment instruction part adjusts the phase of the current flowing through the one or multiple lighting lamps of said first and second systems according to the detection results of said first and second phase detection parts.

4. The lighting control device according to any one of claims 1 to 3, further comprising
a first brightness detection means detecting the brightness of the one or multiple lighting lamps of said first system and
a second brightness detection means detecting the brightness of the one or multiple lighting lamps of said second system,
wherein said power factor adjustment instruction part adjusts the brightness of the one or multiple lighting lamps of said first and second systems according to the detection results of said first and second brightness detection means.

5. The lighting control device according to any one of claims 1 to 4, wherein when the brightness of said one or multiple lighting lamps exceeds a given value, said power factor adjustment instruction part adjusts the brightness of the one or multiple lighting lamps of said first and second systems for the given value or lower.

6. The lighting control device according to any one of claims 1 to 5,
wherein said first and second adjustment switches include:
a bridge circuit consisting of four reverse conducting semiconductor switches; and
a capacitor connected between the direct current terminals of said bridge circuit for accumulating the magnetic energy of the current at the current cutoff and recovering it for said one or multiple lighting lamps,
said adjustment parts send control signals to the gates of said reverse conducting semiconductor switches to turn on/off two pairs of reverse conducting semiconductor switches, each pair consisting of reverse conducting semiconductor switches on each diagonal line of said bridge circuit, in sync with the frequency of said alternating current source in the manner that one pair is turned on while the other is turned off so as to adjust the load power energy supplied to said one or multiple lighting lamps.

7. The lighting control device according to any one of claims 1 to 5,
wherein said first and second adjustment switches have a vertical half-bridge structure including:
two series-connected reverse conducting semiconductor switches;
two capacitors series-connected to each other and parallel-connected to said two reverse conducting semiconductor switches; and
two diodes parallel-connected to said two capacitors, respectively.

8. The lighting control device according to any one of claims 1 to 5,
wherein said first and second adjustment switches have a horizontal half-bridge structure including:
a reverse conducting semiconductor switch and a capacitor that are series-connected on a first path;
a reverse conducting semiconductor switch and a capacitor that are series-connected on a second path that is parallel to said first path; and
a line parallel-connected to said first and second paths.

9. The lighting control device according to any one of claims 1 to 8, wherein said lighting lamp including an inductive load is a discharge lamp.

10. The lighting control device according to claim 9, wherein said discharge lamp is a fluorescent lamp, mercury lamp, sodium lamp, or neon lamp.

11. The lighting control device according to any one of claims 1 to 8, wherein said lighting lamp connected to the inductive load is an incandescent lamp or LED to which a reactor is connected.
